(19) United States
(12) Patent Application Publication
(10) Pub. No.: US 2026/0113195 A1
(43) Pub. Date: Apr. 23, 2026

(54) DEVICE BINDING USING CRYPTOGRAPHIC KEYS

(71) Applicant: Visa International Service Association, San Francisco, CA (US)

(72) Inventors: Sramana Chakraborti, Pleasanton, CA (US); Ramesh Shankar, San Mateo, CA (US); Dmitri Bannikov, Mountain View, CA (US); Tony Kollamparambil, Livermore, CA (US)

(73) Assignee: Visa International Service Association, San Francisco, CA (US)

(21) Appl. No.: 19/475,733

(22) PCT Filed: May 2, 2025
(86) PCT No.: PCT/US2025/027583

§ 371 Date: Oct. 15, 2025

Related U.S. Application Data
(60) Provisional application No. 63/642,585, filed on May 3, 2024.

(51) Int. Cl. H04L 9/32

(52) U.S. Cl. CPC H04L 9/3231; H04L 9/3213

(57) ABSTRACT

A method is disclosed. The method includes receiving, from a user device storing a private key of a public-private key pair, a first attestation message comprising a first attestation data packet, the public key, a user device identifier for the user device, and a credential. The method also includes binding the credential to the user device identifier, and transmitting, to a token service computer, the first attestation data packet. The token service computer previously bound a first token from a first token requestor interacting with the user device to the user device identifier. The method includes receiving, from a second token requestor interacting with the user device, a second attestation message comprising a second attestation data packet, verifying, the second attestation data packet using the public key, and transmitting, verification data to the second token requestor. The second token requestor transmits the verification data to the token service computer.

### CROSS-REFERENCES TO RELATED APPLICATIONS

This application is a PCT application claiming priority to U.S. Provisional Application No 63/642,585, filed May 3, 2024, which is incorporated by reference herein in its entirety.

### BACKGROUND

Token requestors can request tokens associated with credentials from a token service computer. However, current protocols can include a large number of authentication processes. For example, each token provisioning process can require the performance of a step-up authentication process, wherein the token service computer requests additional authentication with respect to a user associated with a credential. For example, if a user is associated with three different token requestors (e.g., an online streaming platform, a digital wallet, and a resource provider), then three different step-up authentication processes may need to be performed. These authentication steps can unnecessarily consume system resources and time, thereby causing the system to be inefficient.

Embodiments of the disclosure address these and other problems individually and collectively.

### SUMMARY

One embodiment includes a method comprising: receiving, from a user device storing a private key of a public-private key pair, a first attestation message comprising a first attestation data packet, a public key of the public-private key pair, a user device identifier for the user device, and a credential; binding the credential to the user device identifier; transmitting, to a token service computer, the first attestation data packet, wherein the token service computer previously bound a first token from a first token requestor interacting with the user device to the user device identifier; receiving, from a second token requestor interacting with the user device, a second attestation message comprising a second attestation data packet; verifying, the second attestation data packet using the public key; and transmitting, verification data to the second token requestor, which transmits the verification data to the token service computer, wherein the token service computer binds a second token associated with the second token requestor to the user device identifier.

Another embodiment includes server computer comprising a processor; and a non-transitory computer-readable medium comprising code that, when executed by the processor, causes the processor to perform a method including: receiving, from a user device storing a private key of a public-private key pair, a first attestation message comprising a first attestation data packet, the public key, a user device identifier for the user device, and a credential; binding the credential to the user device identifier; transmitting, to a token service computer, the first attestation data packet, wherein the token service computer previously bound a first token from a first token requestor interacting with the user device to the user device identifier; receiving, from a second token requestor interacting with the user device, a second attestation message comprising a second attestation data packet; verifying, the second attestation data packet using the public key; and transmitting, verification data to the second token requestor, which transmits the verification data to the token service computer, wherein the token service computer binds a second token associated with the second token requestor to the user device identifier.

Another embodiment includes a method comprising: receiving, by a token service computer from a first token requestor computer, a first device binding request message comprising a user device identifier for a user device and a first token, wherein the first token is associated with a credential; initiating, by the token service computer, a step-up authentication of a user of the user device via an authorizing entity computer associated with the credential; receiving, by the token service computer, an authentication response message; storing, by the token service computer, the user device identifier with first the token; receiving, by the token service computer from a server computer, an enrollment message comprising an enrollment data packet, a user device identifier for the user device, and the credential; receiving, by the token service computer from a second token requestor, a second device binding request message comprising verification data, the user device identifier, and a second token; determining, by the token service computer, that the second token is associated with the credential; determining, by the token service computer, that the credential is associated with the user device identifier; and without initiating a subsequent step-up authentication of the user via the authorizing entity computer, storing, by the token service computer, the second token with the user device identifier.

Another embodiment of the invention includes a token service computer comprising a processor, and a computer readable medium coupled to the processor. The computer readable medium comprises code, executable by the processor, for performing a method. The method comprises: receiving, from a first token requestor computer, a first device binding request message comprising a user device identifier for a user device and a first token, wherein the first token is associated with a credential; initiating a step-up authentication of a user of the user device via an authorizing entity computer associated with the credential; receiving an authentication response message; storing, by the token service computer, the user device identifier with the first token; receiving, from a server computer, an enrollment message comprising an enrollment data packet, a user device identifier for the user device, and the credential; receiving, from a second token requestor, a second device binding request message comprising verification data, the user device identifier, and a second token; determining that the second token is associated with the credential; determining that the credential is associated with the user device identifier; and without initiating a subsequent step-up authentication of the user via the authorizing entity computer, storing, by the token service computer, the second token with the user device identifier.

These and other embodiments are described in further detail below.

### BRIEF DESCRIPTION OF THE DRAWINGS

FIG. 1 shows a system and a process flow for an initial device binding of a first token associated with a first token requestor according to embodiments.

FIG. 2 shows a system and a process flow for enrolling with a server computer and creating a key pair according to embodiments.

FIG. 3 shows a system and a subsequent device binding process involving a second token associated with a second token requestor according to embodiments.

FIG. 4 shows an interaction between a user operating a user device and a second token requestor using a second token according to embodiments.

FIG. 5 shows a block diagram of an exemplary user device according to embodiments.

FIG. 6 shows a block diagram of an exemplary server computer according to embodiments.

FIG. 7 shows a block diagram of an exemplary token service computer according to embodiments.

### TERMS

Prior to discussing embodiments of the disclosure, some terms can be described in further detail.

An “authorizing entity” may be an entity that authorizes a request. Examples of an authorizing entity may be an issuer, a government agency, a document repository, an access administrator, etc. An authorizing entity may operate an authorizing entity computer.

An “issuer” may refer to a business entity (e.g., a bank) that issues and optionally maintains an account for a user. An issuer may also issue payment credentials to the consumer that may be stored on a user device.

A “processor” may refer to any suitable data computation device or devices. A processor may include one or more microprocessors working together to accomplish a desired function. The processor may include a CPU including at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s).

A “memory” may be any suitable device or devices that can store electronic data. A suitable memory may include a non-transitory computer-readable medium that stores instructions that can be executed by a processor to implement a desired method. Examples of memories may include one or more memory chips, disk drives, etc. Such memories may operate using any suitable electrical, optical, and/or magnetic mode of operation.

A “user” may include an individual. In some embodiments, a user may be associated with one or more user devices.

A “user device” may be a device that is operated by a user. Examples of user devices may include a mobile phone or device, a smart phone, a card, a personal digital assistant (PDA), a laptop computer, a desktop computer, a server computer, a thin-client device, a tablet PC, etc. Additionally, user devices may be any type of wearable technology device, such as a watch, an earpiece, glasses, etc. The user device may include one or more processors capable of processing user input. The user device may also include one or more input sensors for receiving user input. Example of the input sensors may include accelerometers, cameras, microphones, etc. The user input obtained by the input sensors may be from a variety of data input types, including, but not limited to, audio data, visual data, or biometric data. The user device may include any electronic device that may be operated by a user, which may also provide remote communication capabilities to a network. Examples of remote communication capabilities include using a mobile phone (wireless) network, wireless data network (e.g., 3G, 4G, 5G or similar networks), Wi-Fi, Wi-Max, or any other communication medium that may provide access to a network such as the Internet or a private network.

A “resource provider” may be an entity that can provide a resource such as goods, services, information, and/or access to a location (e.g., a parking space, a transit terminal, etc.). Examples of resource providers include merchants, government authorities, secure data providers, etc. A resource provider may operate one or more access devices.

A “resource provider computer” can be a computer operated by a resource provider. An example of a resource provider computer can be an access device.

A “credential” may be any suitable information that serves as reliable evidence of worth, ownership, identity, or authority. A credential may be a string of numbers, letters, or any other suitable characters that may be present or contained in any object or document that can serve as confirmation.

A “value credential” may be information associated with worth. Examples of value credentials include payment credentials, coupon identifiers, information needed to obtain a promotional offer, etc.

“Payment credentials” may include any suitable information associated with an account (e.g., a payment account and/or payment device associated with the account). Such information may be related to the account or may be derived from information related to the account. Examples of account information may include a bank account number, PAN (primary account number or “account number”), username, expiration date, CVV (card verification value), dCVV (dynamic card verification value), CVV2 (card verification value 2), CVC3 card verification values, etc. CVV2 is generally understood to be a static verification value associated with a payment device. CVV2 values are generally visible to a user (e.g., a consumer), whereas CVV and dCVV values are typically embedded in memory or authorization request messages and are not readily known to the user (although they are known to the issuer and payment processors). Payment credentials may be any information that identifies or is associated with a payment account. Payment credentials may be provided in order to make a payment from a payment account. Payment credentials can also include a username, an expiration date, a gift card number or code, and any other suitable information.

A “token” may be a substitute value for a credential. A token may be a string of numbers, letters, or any other suitable characters. Examples of tokens include access tokens such as payment tokens, data that can be used to access secure systems or locations, etc.

A “token requestor” may be an application, a device, or a system that is configured to perform actions associated with tokens. For example, a token requestor can perform registration with a network token system, request token generation, token activation, token de-activation, token exchange, other token life-cycle management related processes, and/or any other token related processes. A token requestor may interface with a network token system through any suitable communication networks and/or protocols (e.g., using HTTPS, simple object access protocol (SOAP) and/or an extensible markup language (XML) interface, using a secure communication channel such as secure sockets layer (SSL) or transport layer security (TLS), etc.). In some embodiments, a token requestor can be an application provider that provides a user device with a software application that uses the token. For example, an application provider can be a third-party wallet provider that provides a digital wallet application, or an issuer, acquirer, merchant, and/or payment processing network operator that provides a payment application for a user device. A token requestor can also be an original equipment manufacturer, a communication network operator (e.g., mobile network operator), etc. In some embodiments, a token requestor can request tokens for multiple domains and/or channels.

“Tokenization” is a process by which data is replaced with substitute data. For example, a payment account identifier (e.g., a primary account number (PAN)) may be tokenized by replacing the primary account identifier with a substitute number (e.g., a token) that may be associated with the payment account identifier. Further, tokenization may be applied to any other information that may be replaced with a substitute value (i.e., token). Tokenization enhances transaction efficiency and security.

A “cryptogram” may include encrypted information. For example, a cryptogram can be a set of text encrypted with an encryption key.

An “authorization request message” may be a message that requests permission to conduct an interaction. For example, an authorization request message may include an electronic message that is sent to a payment processing network and/or an issuer associated with a payment credential to request authorization for a transaction. An authorization request message according to some embodiments may comply with ISO 8583, which is a standard for systems that exchange electronic transaction information associated with a payment made by a consumer using a payment device or payment account. The authorization request message may include a payment credential such as a PAN or primary account number, or a payment token. An authorization request message may also include additional data elements corresponding to “identification information” including, by way of example only: a service code, a CVV (card verification value), a dCVV (dynamic card verification value), an expiration date, etc. An authorization request message may also include “transaction information,” such as any information associated with a current transaction, such as the transaction amount, merchant identifier, merchant location, etc., as well as any other information that may be utilized in determining whether to identify and/or authorize a transaction.

An “authorization response message” may be an electronic message reply to an authorization request message. In some embodiments, it may be generated by an issuing financial institution or a payment processing network. The authorization response message may include, by way of example only, one or more of the following status indicators: Approval—transaction was approved; Decline—transaction was not approved; or Call Center —response pending more information, merchant must call the toll-free authorization phone number. The authorization response message may also include an authorization code, which may be a code that an issuing bank returns in response to an authorization request message in an electronic message (either directly or through the payment processing network) to the merchant's access device (e.g., POS equipment) that indicates approval of the transaction. The code may serve as proof of authorization. As noted above, in some embodiments, a payment processing network may generate or forward the authorization response message to the merchant.

A “server computer” may include a powerful computer or cluster of computers. For example, the server computer can be a large mainframe, a minicomputer cluster, or a group of servers functioning as a unit. In one example, the server computer may be a database server coupled to a Web server. The server computer may include one or more computational apparatuses and may use any of a variety of computing structures, arrangements, and compilations for servicing the requests from one or more client computers. A server computer can be a cloud computer.

A “key” may include a piece of information that is used in a cryptographic algorithm to transform input data into another representation. A cryptographic algorithm can be an encryption algorithm that transforms original data into an alternate representation, or a decryption algorithm that transforms encrypted information back to the original data. Examples of cryptographic algorithms may include triple data encryption standard (TDES), data encryption standard (DES), advanced encryption standard (AES), etc.

A “public key” may include an encryption key that may be shared openly and publicly. The public key may be configured such that any information encrypted with the public key may only be decrypted using a private key associated with the public key (i.e., a public-private key pair).

A “private key” may include any encryption key that may be protected and secure. A private key may be securely stored at an entity and may be used to decrypt any information that has been encrypted with an associated public key of a public-private key pair associated with the private key.

A “public-private key pair” may refer to a pair of linked cryptographic keys generated by an entity. The public key may be used for public functions such as encrypting a message to send to the entity or for verifying a digital signature which was made by the entity. The private key, on the other hand may be used for private functions such as decrypting a received message or applying a digital signature. In some embodiments, the public key may be authorized by a body known as a Certification Authority (CA) which stores the public key in a database and distributes it to any other entity which requests it. The private key can typically be kept in a secure storage medium and usually only be known to the entity. Public and private keys may be in any suitable format, including those based on Rivest-Shamir-Adleman (RSA) or elliptic curve cryptography (ECC).

A “Fast Identity Online (FIDO) authentication” is a set of open technical specifications that define user authentication mechanisms that reduce the reliance on passwords.

An “authenticator” is something that authenticates an entity. An authenticator can be a separate authentication device, or authentication software on a user device A “FIDO authenticator” is an authentication entity that meets the FIDO Alliance's requirements and which has related metadata. A FIDO authenticator is responsible for user verification, and maintaining the cryptographic material required for the relying party authentication.

“Platform authenticators” are authenticators that are integrated with a user device and capable of capturing an authentication factor. Platform authenticators are called internal authenticators and are used as a part of the FIDO Alliance's FIDO2 authentication standard. Platform authenticators include features embedded with the device as well as biometric scan, although in some cases biometrics might not be required. With platform authenticators, the primary device such as a laptop or smartphone, contains the necessary components of a trusted platform module (TPM), e.g., a Secure Enclave in the Apple example, as well as the fingerprint or facial scanner. When the user actively or passively authenticates, the request is matched against encrypted information on the TPM, and the user may be granted access on the same device.

An “Application Programming Interface” or “API” may include software specifying how components of a system should interact. The API may comprise a set of routines, protocols, and tools on which software applications may be built. An API may be used for a web-based system, operating system, database system, computer hardware or software library, and may include specifications for routines, data structures, object classes, variables, and/or remote calls.

A “user device identifier” can include a sequence of characters used to identify or refer to a user device. A user device identifier can be associated with a particular user device. A user device identifier can include alphanumeric characters that may refer to a user device. Examples of user identifiers can include phone numbers, IP addresses, IMEI numbers, random numbers associated to user devices, etc., or derivatives (e.g., hashes) thereof.

An “interaction” may refer to a reciprocal action, effect, or influence. For example, an interaction could be an exchange or transaction between two or more parties.

### DETAILED DESCRIPTION

Many tokenization methods use cloud tokens for interactions, wherein a token requestor exchanges a credential for a token. For example, the token requestor can be a service provider and may store credentials (e.g., primary account numbers) in a database, and may tokenize the credentials with a token service computer in batches. Once the tokens are created, the token requestors may use the tokens instead of the credentials in authorization request messages. Since the users associated with the credentials are not present to authenticate themselves as the account owners when the tokens are provisioned, the users may be required to authenticate themselves whenever the tokens are used. As such, each time a token is used by a token requestor in a transaction instead of a credential, an authorizing entity that authorizes the transaction may still need to authenticate the user associated with the credential. Embodiments can eliminate this step and can thereby reduce the friction in interaction processing while still enabling token requestors to continue batch tokenization methods.

Further, to reduce the number of redundant authentication requests, a user may designate a “trusted” user device. This designation initiates a device binding process, where a token requestor can request that a token service computer bind an existing token to a user device.

However, the user may still need to provide consent and authentication for each device binding token. Tokens often vary across different token requestors. For example, a first token associated with a first token requestor may be different from a second token associated with a second token requestor. As a result, the user may be required to provide consent and be authenticated multiple times for multiple tokens.

Embodiments of the disclosure are directed towards methods for using device binding tokens and key pairs to process interactions. Embodiments bind a credential to a user device when issuing a device bound token. Embodiments also subsequently enroll the user of the user device associated with the credential in an authentication system that uses cryptographic key pairs. The authentication system can store a private key of a cryptographic key pair in the user device and a public key at a server computer. When the user enrolls in the authentication system, an authorizing entity can validate that the user is an owner of a credential such as a primary account number (PAN). After the authorizing entity validates that the user is the owner, the server computer can store the public key, and map a user device identifier associated with the user device to the credential associated with the account. In a subsequent interaction where a second device binding process with a second token requestor takes place, the user device signs an attestation data packet with the private key of the user device, instead of requesting that the authorizing entity again authenticate the user. The server computer may use the public key to validate that the user has previously been authenticated as the owner of the credential.

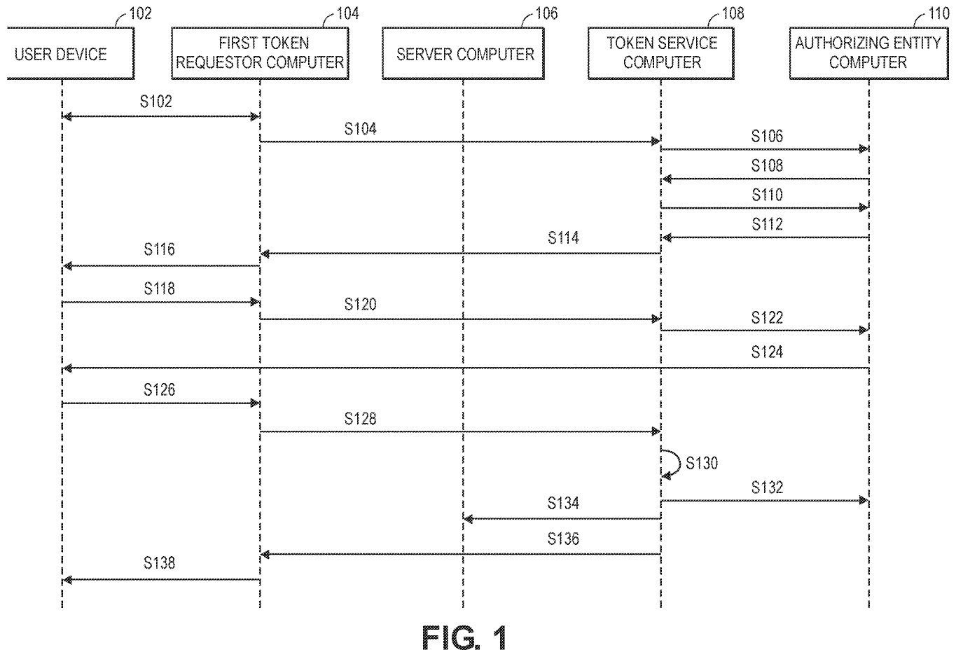

FIG. 1 shows a system and a device binding method according to embodiments. FIG. 1 shows a user device 102 operated by a user, a first token requestor computer 104, a server computer 106, a token service computer 108, and an authorizing entity computer 110 in operative communication with each other.

The user device 102 can be used to authenticate the user. For example, the user device 102 may include a platform authenticator to authenticate a user. The user device 102 can initiate interactions (e.g., transactions) with the first token requestor computer 104. For example, a user operating the user device 102 may initiate checkout or manage a subscription using a website hosted by the first token requestor computer 104 to obtain one or more items.

The first token requestor computer 104 can include any suitable computational apparatus operated by a token requestor (e.g., a merchant). The first token requestor computer 104 can request tokens from the token service computer 108, and use the tokens in interactions. For example, the first token requestor computer 104 can request a token that is associated with the user device 102. In some embodiments, the first token requestor computer 104 may include one or more server computers that may host one or more websites associated with the token requestor (e.g., a merchant). In some embodiments, the first token requestor computer 104 may also be configured to generate authorization request messages for interactions with a user and route the messages to the authorizing entity computer 110 for processing.

The authorizing entity computer 110 may be a server computer operated by an authorizing entity. The authorizing entity computer 110 may authorize requests on behalf of the user of the user device 102. In some embodiments, the authorizing entity computer 110 may issue and manage a credential on behalf of the user operating the user device 102. For example, an example of an authorizing entity may be an issuer, which maintains an account for the user of the user device 102. The account may have an account number, which is an example of a credential.

The server computer 106 may be a computer that can perform public-private key pair authentication (e.g., Fast Identity Online (FIDO) authentication). The server computer 106 may maintain mappings of credentials (e.g., PAN) and device identifiers. In some embodiments, the server computer 106 can be a FIDO server computer.

The token service computer 108 can include a computer that maintains tokens of credentials. The token service computer 108 may associate tokens with user devices to bind the tokens to the user devices. The token service computer 108 may also generate and provision tokens. The token service computer 108 can also store mappings of tokens to credentials.

The method described in reference to FIG. 1 can be performed to bind an existing token (e.g., a first token) associated with the first token requestor computer 104 to the user device 102. The device binding process can enable convenient interactions between the user device 102 and the first token requestor computer 104.

The first token requestor computer 104 may store a first token for a credential associated with the user of the user device 102. The first token may be used to avoid exposure of the underlying credential. Before device binding, whenever the first token is used in an interaction, a step-up authentication may be used to verify the user is associated with the credential/token. For example, each time a first token is used, the authorizing entity may send a one-time passcode to the user via the user device 102 for verification.

Each of the entities in FIG. 1 may communicate through any suitable communication channel or communications network. A suitable communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like,

For simplicity of illustration, a certain number of components are shown in FIG. 1. It should be understood, however, that embodiments of the present disclosure may include more than one of each component. In addition, some systems according to embodiments of the present disclosure may include a smaller number of components or a greater number of components than those shown in FIG. 1.

During device binding, the user device 102 is designated as a “trusted” device and can serve as an authentication factor. A user device identifier may be stored in association with the first token, so that the presence of the user device 102 can be recognized in future interactions. Conveniently, after device binding, step-up authentication need not be performed each time the first token is used.

Prior to step S102, the first token requestor computer 104 may store a first token associated with the user of the user device 102. For example, the first token requestor computer 104 may tokenize a credential (e.g., PAN) associated with the user using the token service computer 108. The first token can be used to replace the credential in interactions. Additionally, prior to step S102, a unique user device identifier may be assigned to the user device 102. The user device identifier may be pre-existing (e.g., a phone number, an IMEI number, etc.) or may be provisioned by the token service computer 108 at the request of the first token requestor computer 104, or another token requestor.

At step S102, the user device 102 may initiate a device binding process. For example, the user device 102 may access a website provided by the first token requestor computer 104 and prompt the user to consent to a device binding process. The user can agree, and the user device 102 may notify the first token requestor computer 104. For example, the user may designate the user device 102 as a “trusted device” so that future interactions initiated by the user device 102 do not require step-up authentication.

At step S104, after receiving consent for device binding from the user device 102, the first token requestor computer 104 may request that the token service computer 108 bind a first token to the user device 102 (e.g., a first device binding request message). For example, the first token requestor computer 104 may transmit the user device identifier associated with the user device 102 and the first token in a device binding request message to the token service computer 108. The first token may be an existing token previously provisioned prior to step S102. The first token may be associated with the first token requestor computer 104 and can be a replacement for the credential associated with the user of the user device 102.

At step S106, after receiving the device binding request comprising the first token and the user device identifier from the first token requestor, the token service computer 108 can determine the authorizing entity computer 110 based on the credential associated with the first token. The token service computer 108 can have a mapping of credential portions (e.g., BINs or bank identifier numbers of PANs or primary account numbers) to authorizing entity computer identifiers or addresses. The token service computer 108 can then transmit the device binding request to the authorizing entity computer 110 that manages the account associated with the credential. The token service computer 118 can provide a token provisioning request message to the authorizing entity computer 110 via an ISO 0100 message or via an application programming interface (API).

At step S108, after receiving the token provisioning request message, the authorizing entity computer 110 can request that the token service computer 108 perform or initiate a step-up authentication prior to binding the first token to the user device 102.

At step S110, after receiving the token provisioning response message, the token service computer 108 can generate and provide a get verification methods message to the authorizing entity computer 110. The get verification methods message can be a request to get cardholder verification methods (CVM) associated with the credential.

At step S112, the authorizing entity computer 110 can obtain one or more verification methods in response to the get verification methods message. The authorizing entity computer 110 can provide the one or more verification methods to the token service computer 108.

At step S114, after receiving the verification methods from the authorizing entity computer 110, the token service computer 108 can provide the verification methods to the first token requestor computer 104 (e.g., in a list of verification methods format).

At step S116, after receiving the verification methods from the token service computer 118, the first token requestor computer 104 can present the verification methods to the user device 102 (e.g., via a webpage).

At step S118, the user of the user device 102 can select one verification method of the one or more verification methods. The user device 102 can provide the selected verification method to the first token requestor computer 104. For example, the user can select a verification method such as a one-time passcode (OTP) verification method.

At step S120, after receiving the selected verification method, the first token requestor computer 104 can provide the selected verification method in an identification and verification (ID&V) message to the token service computer 108. The token service computer 108 can also present an input field that can allow the user device 102 to input authentication information (e.g., the passcode).

At step S122, after receiving the selected verification method, the token service computer 108 can initiate the selected verification method. For example, the token service computer 108 can generate a passcode according to the one-time passcode verification method. After generating the passcode, the token service computer 108 and can send it to the authorizing entity computer 110.

At step S124, the authorizing entity computer 112 can directly provide the passcode to the user device 102. The authorizing entity computer 110 can provide the passcode to the user device 102 in a communication channel that is separate from the communication channel formed between the user device 102 and the first token requestor computer 104. For example, the authorizing entity computer 110 can provide the passcode to the user device 102 via short message service (SMS), email, or other communication channel.

At step S126, after receiving the passcode, the user device 102 can provide the authentication information (e.g., the passcode) to the first token requestor computer 104 to authenticate the user. For example, the user can input the passcode into a passcode input field in the webpage provided by the first token requestor computer 104.

At step S128, after receiving the authentication information (e.g., the passcode), the first token requestor computer 104 can provide the authentication information to the token service computer 108 in an authentication response message.

The token service computer 108 can verify the received authentication information (e.g., the passcode). The token service computer 108 can compare the received passcode to the generated passcode. If the received passcode and the generated passcode do not match, then the token service computer 108 can terminate the process. If the received passcode and the generated passcode match, then the token service computer 108 can proceed to step $130.

At step S130, after verifying the authentication information, the token service computer 108 can bind the first token to the user device 102. For example, the token service computer 108 may store the user device identifier in association with the first token (and also the credential associated with the first token) in a database.

At step S132, after binding the first token to the user device 102, the token service computer 108 can generate and provide a device binding success message to the authorizing entity computer 110. The token service computer 108 can determine, obtain, or generate a transaction identifier (transaction ID) for identifying the transaction. Optionally, the token service computer 108 can record a time of when the authentication and initial device binding is performed. The token service computer 108 may include the transaction ID and the time in the device binding success message to the authorizing entity computer 110. The authorizing entity computer 110 may store the transaction ID and the time of authentication received from the token service computer 108.

At step S134, the token service computer 108 can provide the device binding success message to the server computer 106. At step S136, the token service computer 108 can notify the first token requestor computer 104 of the successful device binding. At step S138, the first token requestor computer 104 may notify user device 102 of successful device binding.

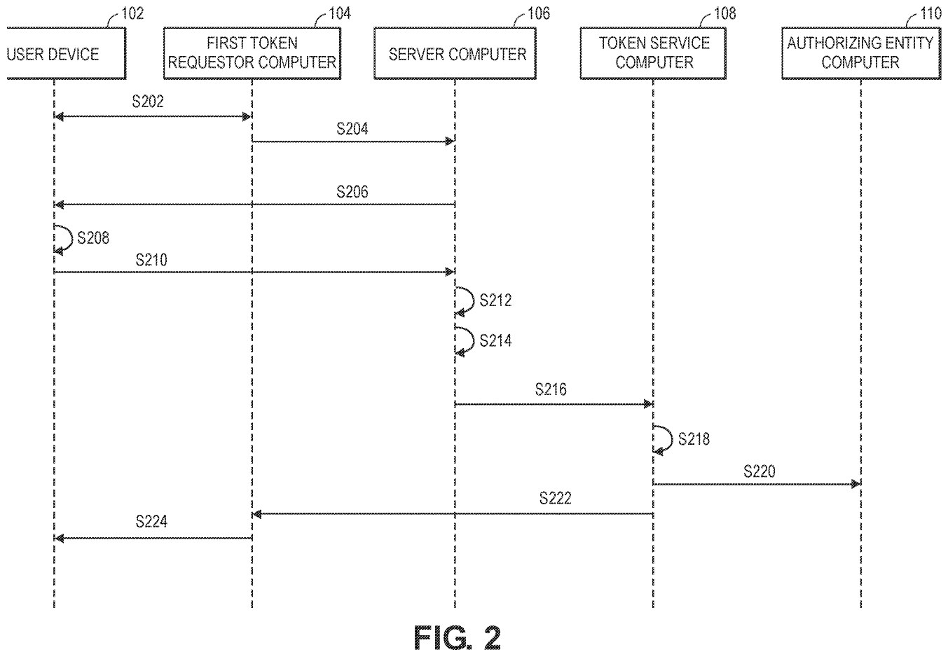

FIG. 2 shows a system and a method for enrolling with a server computer and creating a key pair according to embodiments.

The enrollment process described in reference to FIG. 2 may occur within the same, or different, session as the initial device binding of FIG. 1. Similar to FIG. 1, FIG. 2 shows a user device 102, a first token requestor computer 104, a server computer 106, a token service computer 108, and an authorizing entity computer 110 in operative communication with each other.

The user device 102 can perform an enrollment process which may be similar to a FIDO enrollment process. During the enrollment process, the user device 102 can generate an attestation blob (e.g., in a metadata blob file) and a public key. In some embodiments, the public key can be a FIDO public key.

At step S202, the first token requestor computer 104 may display a user interface on the user device 102 asking the user to enroll with the server computer 106. The user can confirm via the user interface.

At step S204, after receiving the user confirmation, the first token requestor computer 104 can initiate a user authentication process with the server computer 106.

At step S206, the server computer 106 can transmit a message to the user device 102 which launches an enrollment interface. The server computer 106 may additionally generate and transmit to the user device 102 an attestation request packet. The attestation request packet may include a challenge, a server computer identifier, an authenticator selection, an attestation setting, a user verification setting, a user present setting, etc. The challenge can be a random number generated to prevent replay attacks. The server computer identifier can be a unique identifier (e.g., a valid domain string, application address, etc.) that identifies the server computer domain.

The authenticator selection can be specific authenticator information that the server computer 106 may require for verification. For example, the server computer 106 may require a specific type of platform authenticator (e.g., a biometric scanner to capture a user biometric). In an embodiment, the server computer 106 may require a platform authenticator that is a FIDO authenticator.

The attestation setting can allow the first token requestor computer 104, the server computer 106, or other entity, to specify whether the attestation data is required. The attestation data may include an authenticator attestation globally unique ID (AAGUID) that indicates the certified FIDO device. The same AAGUID may be assigned to security keys whose product type and firmware are the same.

In some embodiments, the server computer 106 can set the attestation setting to “direct.” Such setting specifies that the attestation of the FIDO certification is required, e.g., the user device 102 must be a certified FIDO device possessing an AAGUID.

The user verification setting and the user present setting may allow the server computer 106 to instruct the user device 102 whether the user verification and the user presence are required. In embodiments, the user verification setting and the user present setting may be set by the server computer 106 to indicate that the user verification and the user presence are required.

At step S208, upon receiving the authenticator attestation request packet, user device 102 can facilitate user authentication. For example, the user device 102 can authenticate the user (e.g., by using user-provided PIN, user biometric information, etc.). In addition to the user authentication, the user device 102 can determine if the user is present during authentication, which can involve an affirmative user gesture (e.g., touching the user device 102) or a real-time user image (e.g., a user biometric) can be captured by an image sensor (e.g., a biometric scanner) included in the user device 102.

In some embodiments, the user device 102 can generate a new cryptographic key pair, e.g., a public-private key pair specific to the server computer 106. The user device 102 can store the assertion private key and the server computer identifier in a database within the user device 102 (e.g., in the secure element of the user device 102).

The user device 102 can generate a credential identifier (ID) that contains information about the public key, the private key, and/or server computer identifier. For example, the credential ID may include information about the location of the new private key and the server computer identifier in the database of the user device 102.

The user device 102 may generate a first attestation data packet that may include client data and an attestation object. The user verification flag and the user present flag can be set to “true” indicative of user successful verification (e.g., PIN, or biometric authentication) and user presence. For example, a value of “true” can be 1, among 0 and 1.

For example, the client data can include one or more of a challenge, server computer identifier or server computer identifier hash, and extensions. The authenticator data can include a user verification flag, a user present flag, the AAGUID, the public key of the public-private key pair, a credential ID, etc. In some embodiments, the authenticator data can further include a cryptographic algorithm identifier for a cryptographic algorithm used to generate the public-private key pair.

In some embodiments, the attestation object can include an attestation format, the authenticator data, and an attestation statement. In some embodiments, the attestation format can be used to determine how to verify the attestation statement. For example, the attestation format can be “packed,” “fido-u2f”, “none”, “android-key”, “android-safetynet”, “tpm”, “apple”, etc.

The structure of the attestation statement and the procedures to verify it may depend on the type of the attestation format that is defined in the attestation object. In some embodiments, the attestation statement can include an attestation signature and the attestation certificate.

In some embodiments, the user device 102 can use the private key and a first concatenated value to generate an attestation signature. For example, the attestation signature can be used to sign the first concatenated value, to generate the attestation signature. The first concatenated value can be a concatenation of a hash of the authenticator data and a client data hash that is determined by applying a hash algorithm to the authenticator data and the client data hash. Alternatively, the first concatenated value can be a concatenation of a hash of the authenticator data and client data that is determined by applying a hash algorithm to the authenticator data and the client data. The hash algorithm may be SHA-256 or any other suitable hash algorithm.

At step S210, the user device 102 can send a first attestation message comprising the first attestation data packet, the public key, a user device identifier, and a credential to the server computer 106 as a response to receiving the attestation request packet. The credential may be the same credential underlying the first token as described in reference to FIG. 1.

At step S212, upon receiving the first attestation message from the user device 102, the server computer 106 can verify first attestation data packet comprising the client data and the attestation object.

As described in detail below, in some embodiments, the server computer 106 can verify the server computer identifier, the challenge in the client data, the attestation signature, the user verification flag, the user present flag, AAGUID, and the attestation certificate. If any of the verifications fail, the enrollment process can abort.

For example, the server computer 106 may verify that the server computer identifier in the client data is the same as the origin server computer identifier (e.g., URL) of the server computer 106, to verify that there is no phishing or man-in-the-middle attack between the user device 102 and the server computer 106.

The server computer 106 can verify that the challenge in the client data matches the challenge sent in the authenticator attestation request packet and confirm that the user verification flag and the user present flag are set to “true.”

The server computer 106 can verify the attestation signature of the attestation object using the public key. For example, the server computer 106 can use the attestation signature and the attestation public key, to determine the first concatenated value. The server computer 106 may generate a second concatenated value. If the client data hash is received, the second concatenated value can be a concatenation of a hash of the received authenticator data and the received client data hash that is determined by applying a hash algorithm to the received authenticator data and the received client data hash. Alternatively, if the client data is received that is not hashed, the second concatenated value is a concatenation of a hash of the received client data and authenticator data that is determined by applying a hash algorithm to the received client data and authenticator data. If the first concatenated value matches the second concatenated value, then the attestation signature is considered as verified.

In some embodiments, the server computer 106 can verify the received attestation certificate, which is used for the verification of authenticity of the attestation signature. The attestation certificate can be verified by using the received AAGUID. The AAGUID can be used to look up a metadata statement in a service such as Metadata Service (MDS) to validate authenticator attestation and prove the genuineness of the device model. The metadata statement can have an attestation root certificate and the metadata about the user device 102 such as security and biometric characteristics of the device. The root certificate can be used to check the authenticity of the attestation certificate. In some embodiments, other metadata including the security and biometric characteristics can be checked by the server computer 106 to determine the security level of the user device 102.

Attestation accomplishes several security checks. For example, if an attacker intercepts the authenticator attestation response packet, the attacker would not be able to swap out the new public key with its own since the attestation signature would not match. As another example, knowing the provenance of the user device 102 can provide the relying party with information regarding the security of the encryption keys, the security of the biometrics verification process, etc.

At step S214, upon successful verifications, the server computer 106 can store the user device identifier with the credential in memory, thereby binding the user device 102 to the credential. The server computer 106 may additionally store the credential ID, AAGUID, the public key in memory. The server computer 106 can also store a cryptographic algorithm identifier for a cryptographic algorithm used to generate the public-private key pair in correspondence to the public key.

At step S216, the server computer 106 can transmit an enrollment message comprising an enrollment authentication data packet (e.g., an enrollment blob or enrollment payload) to the token service computer 108. The enrollment authentication data packet can include one or more of an authentication time, a server computer identifier, a public key, an AAGUID, a used for this transaction flag, a user present flag, a user verification flag, a cryptographic algorithm identifier for a cryptographic algorithm used to generate the public-private key pair, and a transaction ID.

At step S218, the token service computer 108 can validate the information provided in the enrollment authentication data packet and, in the case of successful validation, store the enrollment blob in a memory.

As described in detail below, in some embodiments, the token service computer 108 can validate (e.g., verify) the AAGUID (e.g., by looking up the AAGUID using the MDS), the time period between the time of the enrollment and the time of authentication (i.e., time of prior authentication), and transaction ID. For example, the transaction ID may include time of prior authentication.

For example, the token service computer 108 can retrieve the previously stored transaction ID (e.g., from step S132 of FIG. 1) and verify the transaction ID in the enrollment blob by comparing the transaction ID in the enrollment blob with the previously stored transaction ID. For example, a match must be determined for successful verification (e.g., validation).

The token service computer 108 can verify that the time period between the time of the enrollment, e.g., an enrollment time, and the time of authentication is less than a threshold time period value. For example, the threshold time period value may be set to 2 minutes, 5 minutes, 10 minutes, etc. For example, if a difference between the time of prior authentication and the time of the enrollment recorded in the enrollment blob is more than the threshold time period value, the token service computer 108 does not validate the time period. Otherwise, the token service computer 108 validates the time period.

Upon completing successful validation of the AAGUID, the time period, and the transaction ID (if available), the token service computer 108 can store the enrollment blob in the memory associated with the token service computer 108. For example, the cryptographic algorithm identifier for the cryptographic algorithm used to generate the assertion public-private key pair may be stored in correspondence with the assertion public key.

At step S220, the token service computer 108 can send the enrollment authentication data packet with an indication that the user was successfully enrolled to the authorizing entity computer 110.

In some embodiments, the authorizing entity computer 110 may store the enrollment blob in a memory associated with the authorizing entity computer 110. Upon receiving the enrollment blob, the authorizing entity computer 110 can retrieve the previously stored transaction ID (from step S132 of FIG. 1) and verify the transaction using the transaction ID from the enrollment blob.

At step S222, the token service computer 108 can notify the first token requestor computer 104 of successful enrollment. At step S224, the first token requestor computer 104 may notify the user device 102 that enrollment is successful.

In subsequent interactions which may require a password, the user can instead provide a biometric to the user device 102. Whenever the user submits the biometric, the user device can sign an attestation data packet with a private key and send the signed attestation data packet to be verified using the public key, by the server computer 106. Successful verification of the attestation data packet can result in positive authentication by the server computer 106.

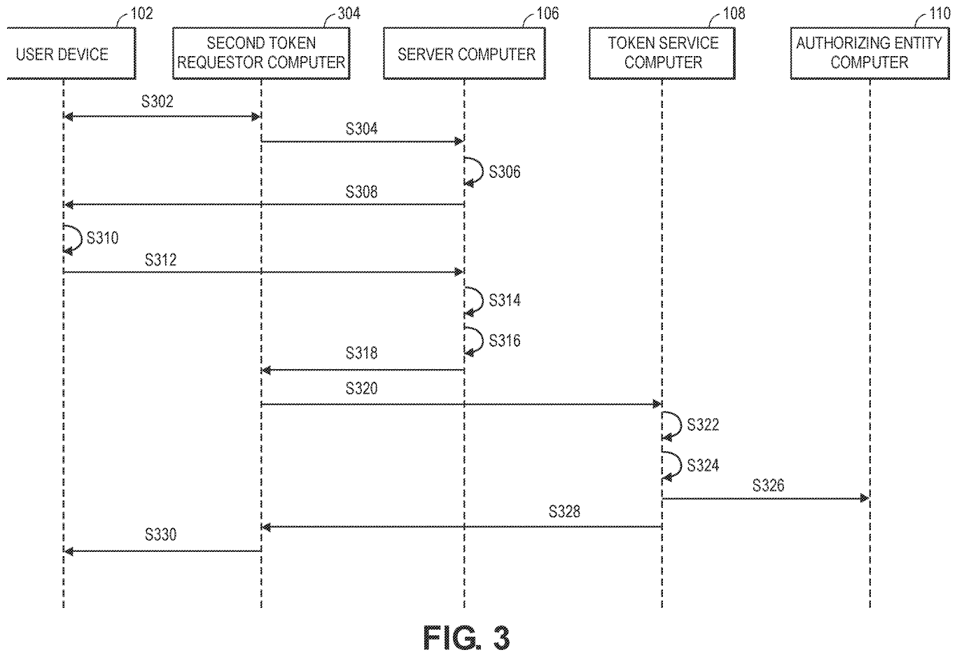

FIG. 3 shows a system and a device binding process for a second token with a second token requestor after completion of an enrollment process. The process illustrated in FIG. 3 can occur at any point after the processes of FIG. 1 and FIG. 2 are completed. Similar to FIG. 1 and FIG. 2, FIG. 3 can involve a user device 102, a server computer 106, a token service computer 108, and an authorizing entity computer 110. FIG. 3 also includes a second token requestor computer 304.

The second token requestor computer 304 may be a separate entity from the first token requestor computer 104 described with reference to FIG. 1. The second token requestor computer 304 can store a second token of the credential associated with the user of the user device 102. The second token and the first token described in reference to FIG. 1 may both be associated with the same credential.

In the device binding process of FIG. 3, the user of the user device 102 does not need to authenticate to with the authorizing entity computer 110 to bind the second token to the user device 102 since authentication was already performed during the initial device binding flow of FIG. 1.

At step S302, the user device 102 may initiate a device binding process. For example, the user device 102 may access a website provided by the second token requestor computer 304, and prompt the user to consent for a device binding process. The user can agree, and the user device 102 may notify the second token requestor computer 304. For example, the user may designate the user device 102 as a “trusted device” for convenient log-in.

At step S304, after receiving consent for device binding from the user device 102, the second token requestor computer 304 may transmit to the server computer 106 an indication to perform a verification process for the user device 102.

At step S306, the server computer 106 may generate a second attestation request data packet to include the credential parameters (e.g., a server computer identifier, a credential ID, and a challenge). The assertion request data packet may specify that the user verification and/or the user presence are required. The credential parameters are described above.

At step S308, the server computer 106 may send the second attestation request data packet including a server computer identifier, a credential ID, and a challenge to the user device 102.

At step S310, upon receiving the second attestation request data packet, the user device 102 can perform an assertion process and generate an assertion response data packet, as a response to the assertion request data packet.

The user device 102 may compare the server computer identifier with its origin (e.g., URL) to verify that there is no phishing or man-in-the-middle attack between the user device 102 and the server computer 106. If the server computer identifier does not match its origin (e.g., URL), the process aborts,

The user device 102 can retrieve the assertion private key and server computer identifier stored in a database using the credential ID. The server computer identifier received from the server computer 106 is then compared with the server computer identifier stored in the user device 102 to verify that the correct assertion private key has been retrieved.

The user device 102 can generate client data including any of the challenge, server computer identifier, extensions, and a hash algorithm. In some embodiments, the user device 102 can generate a client data hash.

The user device 102 can then conduct user presence and user verification that are processes similar to what is described above with reference to FIG. 2. Upon successful user verification and user presence check, the user present flag and the user verification flag can be set “true.” The user device 102 can also generate a signature counter, where the signature counter increments every time the user device 102 authenticates the user. The signature counter can be used by the server computer 106 to detect cloned authenticators. The user device 102 can then generate authenticator data including the AAGUID, the user present flag, user verification flag, extensions, and the signature counter.

The user device 102 can use the assertion private key on a first concatenated value to generate an assertion signature. For example, the first concatenated value may be signed with the assertion private key to generate an assertion signature. The first concatenated value can be a concatenation of a hash of the authenticator data and the client data that is obtained by applying a hash algorithm on the authenticator data and the client data. Alternatively, the first concatenated value may be a concatenation of a hash of the authenticator data and the client data hash that is obtained by applying a hash algorithm on the authenticator data and the client data hash. The hash algorithm may be SHA-256 or any other suitable hash algorithm.

The user device 102 can generate a second attestation message comprising a second attestation data packet. The second attestation data packet may include the server computer identifier, the authenticator data, the client data, the credential ID, and the assertion signature.

At step S312, the user device 102 can send the second attestation message comprising the second attestation data packet to the server computer 106, as a response to the second attestation data request packet.

At step S314, the server computer 106 can verify the second attestation data packet.

As described in detail below, in some embodiments, the server computer 106 can verify the server computer identifier, the challenge in the client data, the assertion signature, the user verification flag, the user present flag, the credential ID, and AAGUID. If any verification fails, the process aborts.

The server computer 106 can verify that the challenge in the client data matches the generated challenge, the user verification flag and the user present flag are set as “true,” the AAGUID of the authenticator data matches the AAGUID used during the enrollment, and the credential ID of the assertion data response packet matches the stored credential ID.

The server computer 106 can also validate (e.g., verify) the assertion signature. For example, the server computer 106 can use the assertion public key and the assertion signature to determine the first concatenated value. In some embodiments, the server computer 106 can apply a predefined algorithm on the assertion public key and the assertion signature to determine the first concatenated value. In some embodiments, the predefined algorithm may be the cryptographic algorithm used to generate the assertion public-private key pair. The server computer 106 can further generate a second concatenated value. In some embodiments, the second concatenated value can be a concatenation of a hash of the received authenticator data and client data. If the client data that is received is hashed, then the second concatenated value can be a concatenation of the received authenticator data and the received client data hash. The hash algorithm may be SHA-256 or any other suitable hash algorithm. If the first concatenated value matches the second concatenated value, then the assertion signature is validated (e.g., verified).

In some embodiments, the server computer 106 can ensure, e.g., determine, that all verifications are successful; otherwise, the assertion/authentication can be aborted.

At step S316, in response to all the validations and verifications being successful, the server computer 106 can generate verification data. The verification data may comprise an authentication data packet, e.g., an authentication payload or an authentication blob. For example, the authentication data packet transmitted to the token service computer 108 includes a requestor authentication method and authentication data.

The requestor authentication method can be represented by a string corresponding to the authentication method, e.g., 3DS.

The authentication data includes an authentication time, server computer identifier, an authenticator ID (e.g., AAGUID), a used for this transaction flag, a user present flag, a user verification flag, an assertion signature, the client data, and the authenticator data. Each of the authentication time, server computer identifier, AAGUID, a used for this transaction flag, a user present flag, a user verification flag, an assertion signature, the client data, and the authenticator data may be disposed in a corresponding data field of the authentication data packet. For example, each of the authentication time, server computer identifier, AAGUID, a used for this transaction flag, an assertion signature, the client data, and the authenticator data can be represented by a string. Each of the user present flag and the user verification flag can be a Boolean bit flag.

The authentication time, the server computer identifier, the AAGUID, the user present flag, the user verification flag, the assertion signature, the client data, and the authenticator data are described above. If the server computer identifier and the AAGUID match the previously used server computer identifier and AAGUID, the processing proceeds. The user present flag and the user verification flag can be set to “true,” e.g., 1. The used for this transaction flag can be set to true indicating that the same authenticator was used to authenticate the current session with the resource provider.

At step S318, the server computer 106 can transmit the verification data comprising the authentication data packet to the second token requestor computer 304.

At step S320, upon receiving the verification data the second token requestor computer 304 can generate and transmit a second device binding request message to the token service computer 108. The second device binding request message can comprise the user device identifier of the user device 102, the second token, and the verification data comprising the authentication data packet. The second token may be an existing token previously provisioned prior to step S302. The second token may be associated with the second token requestor computer 304 and be a replacement for the credential associated with the user of the user device 102.

At step S322, the token service computer 108 can verify the information in the authentication data packet. In certain embodiments, the token service computer 108 may store the authentication data packet, e.g., in a database in correspondence to the user device ID, if the verifications/validations described below are successful.

As described in detail below, in some embodiments, the token service computer 108 can validate (e.g., verify) the server computer identifier, the AAGUID, the assertion signature, the user present flag, and the user verification flag.

For example, the token service computer 108 may use the AAGUID to check that the same authentication device (e.g., the user device 102) is used for the assertion as was used during the enrollment. The token service computer 108 can check that the user present flag and the user verification flag are set to true. The token service computer 108 can check that server computer identifier matches the resource provider. The token service computer 108 can verify the assertion signature using the assertion public key similar to operation S222.

In certain embodiments, the token service computer 108 can ensure, e.g., determine, that all verifications are successful; otherwise, the device binding process can be aborted.

The token service computer 108 may identify that an initial device binding process was performed for the user device 102. For example, the token service computer 108 may determine that the user device identifier is stored in association with the first token, and the first token is associated with the same credential as the second token. The token service computer 108 can determine that the authorizing entity computer 110 already performed a step-up authentication for the credential and the user device 102. The token service computer 108 can determine that the authorizing entity computer 110 does not need to re-authenticate the combination of the credential and the user device 102 for the second device binding.

At step S324, upon successful verifications at step S322, the token service computer 108 can bind the second token to the user device 102. For example, the token service computer 108 may store the user device identifier in association with the second token (and also the credential associated with the first token and the second token).

At step S326, the token service computer 108 can generate and provide a device binding notification for the second token to the authorizing entity computer 110.

At step S328, the token service computer 108 can generate and provide a device binding notification for the second token to the second token requestor computer 304.

At step S330, the second token requestor computer 304 may notify the user device 102 that device binding is complete.

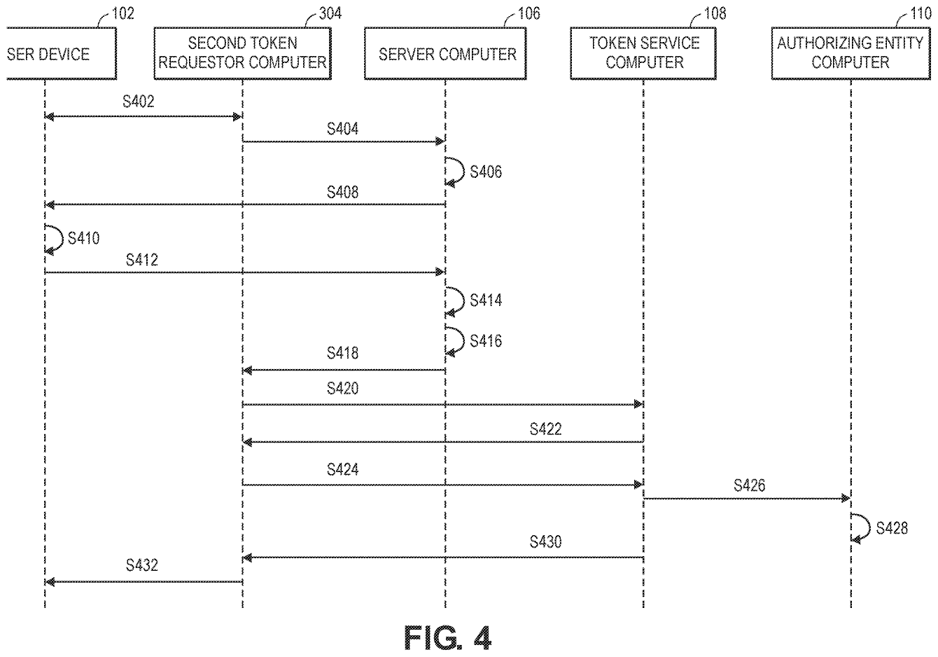

FIG. 4 shows a process flow of an interaction after an initial device binding process and an enrollment process. FIG. 4 may take place after the processes of FIG. 1, FIG. 2, and FIG. 3 are complete. The interaction described with reference to FIG. 4 can involve the same entities as described in FIG. 3, and the second token. In some embodiments, the interaction can involve the first token requestor computer 104 from FIG. 1 and the first token.

At step S402, the user device 102 can initiate an interaction with the second token requestor computer 304. The user of the user device 102 may interact with the second token requestor computer 304, for example, when the user wishes to pay for goods or services.

At step S404, the server computer 106 may receive from the second token requestor computer 304, an indication to perform a verification process associated with the interaction.

Steps S406-S418 may be similar to S306-S318 of FIG. 3 and the description thereof will not be repeated here.

At step S420, after receiving the verification data from the server computer 106, the second token requestor computer 304 can request interaction data from the token service computer 108. The second token requestor computer 304 can transmit the authentication data packet to the token service computer 108. For example, the second token requestor computer 304 may transmit to the server computer 106 an API request for interaction data comprising the authentication data packet.

At step S422, after receiving the authentication data packet from the second token requestor computer 304, the token service computer 108 can generate a cryptogram or a message (e.g., ECI 05/CAVV) for the interaction using the authentication data packet to indicate that validation is successful. For example, a cryptogram may be an authentication cryptogram. The token service computer 108 can transmit an API response comprising the cryptogram to the second token requestor computer 304.

At step S424, the second token requestor computer 304 can send to the token service computer 108 via a transport computer (e.g., an acquirer computer) an authorization request message. The token service computer 108 may be in a payment processing network, which can process transaction authorization, clearing, and settlement transactions. The authorization request message may include an interaction amount, the second token, and the cryptogram. The cryptogram in the authorization request message notifies the token service computer 108 about the previously successful authentication of the user. For example, in some embodiments, the cryptogram in the authorization request message may include an authentication cryptogram generated in step S430.

At step S426, the token service computer 108 can modify the authorization request message by including the credential. The token service computer 108 can detokenize the second token to obtain the credential, and replace the second token with the credential. The token service computer 108 can transmit the modified authorization request message comprising the credential to the authorizing entity computer 110.

At step S428, upon receiving the modified authorization request message, the authorizing entity computer 110 may determine whether to authorize the transaction. In addition to determining if the user has sufficient funds in their account, the authorizing entity computer 110 can use the data in the authentication data packet in the authorization request message to determine if the current transaction is authorized. The authentication data is detailed and can provide the authorizing entity (e.g., the issuer) with assurance that the transaction is authentic.

At step S430, the authorizing entity computer 110 can send an authorization response message to the token service computer 108 including either an acceptance or rejection of the authorization request message. If the authorizing entity computer 110 authorizes the authorization request message, then the interaction successfully proceeds. If the authorizing entity computer 110 declines the authorization request message, then the interaction terminates.

At step S432, the token service computer 108 can modify the authorization response message to include the second token and send the modified authorization response message to the second token requestor computer 304.

At a later date or time, a clearing and settlement process may take place between the transport computer (not shown) operated by an acquirer associated with the second token requestor computer 304, the token service computer 108 and the authorizing entity computer 110.

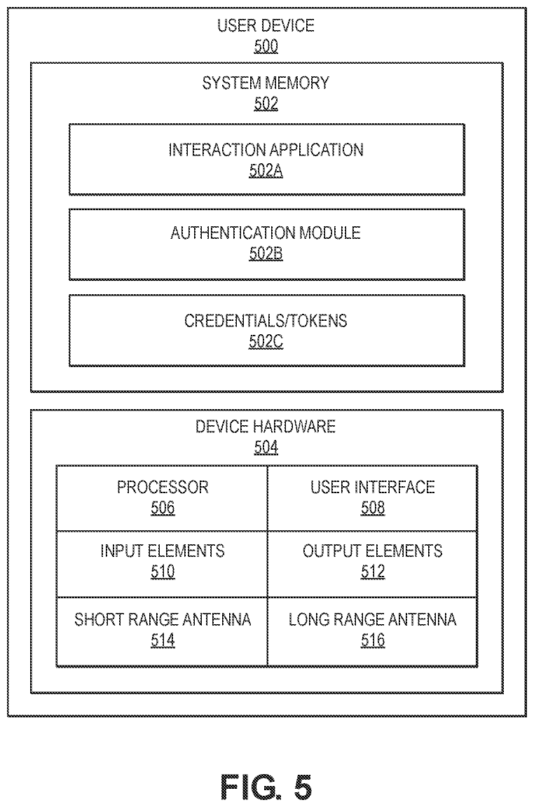

FIG. 5 shows a block diagram of a user device 500 in according to an embodiment. The user device 500 may correspond to the user device 102 described above and may include device hardware 504 coupled to a system memory 502, e.g., a computer-readable storage medium.

Device hardware 504 may include a processor 506, a short-range antenna 514, a long-range antenna 516, input elements 510, a user interface 508, and output elements 512 (which may be part of the user interface 508). Examples of input elements may include microphones, keypads, touchscreens, sensors, etc. Examples of output elements may include speakers, display screens, and tactile devices.

The long-range antenna 516 may include one or more RF transceivers and/or connectors that can be used by user device 500 to communicate with other devices and/or to connect with external networks. The user interface 508 can include any combination of input and output elements to allow a user to interact with and invoke the functionalities of user device 500. The short-range antenna 509 may be configured to communicate with external entities through a short-range communication medium (e.g., using Bluetooth, Wi-Fi, infrared, NFC, etc.). The long-range antenna 516 may be configured to communicate with a remote base station and a remote cellular or data network, over the air.

The system memory 502 can be implemented using any combination of any number of non-volatile memories (e.g., flash memory) and volatile memories (e.g., DRAM, SRAM), or any other non-transitory storage medium, or a combination thereof media. The system memory 502 can be in the form of (or may be included in) a memory element that stores data (e.g., resource provider applications) and can be in any suitable form (e.g., microSD chip, SIM card, or other type of memory element).

The system memory 502 may also store an interaction application 502A, an authentication module 502B, a cryptography module 508C, and credentials, keys, and tokens 502D. The interaction application 502A may include instructions or code initiating and conducting an interaction with an external device such as a first token requestor computer. It may include code, executable by the processor 506, for generating and transmitting device binding request messages, as well as receiving response messages. It may also include code, executable by the processor 506, for forming a local connection or otherwise interacting with an external device (e.g., an Operator computer). The authentication module 502B may include code, executable by the processor 506, to authenticate a user. This can be performed using user secrets (e.g., passwords), user biometrics, public-private keys, etc. System memory 502 may also store credentials, keys, and tokens 502C or references.

The cryptography module 508C may comprise code that causes the processor 506 to provide cryptographic functionalities. The cryptography module 508C may enable the user device 500 to sign data using a private key. For example, the cryptography module 508C may encrypt or hash data elements to generate an attestation data packet. For example, cryptography module 508C may implement and perform encryption operations using encryption algorithms such as DES, AES, TDES/TDEA, or the like, and/or hash functions such as SHA, or the like.

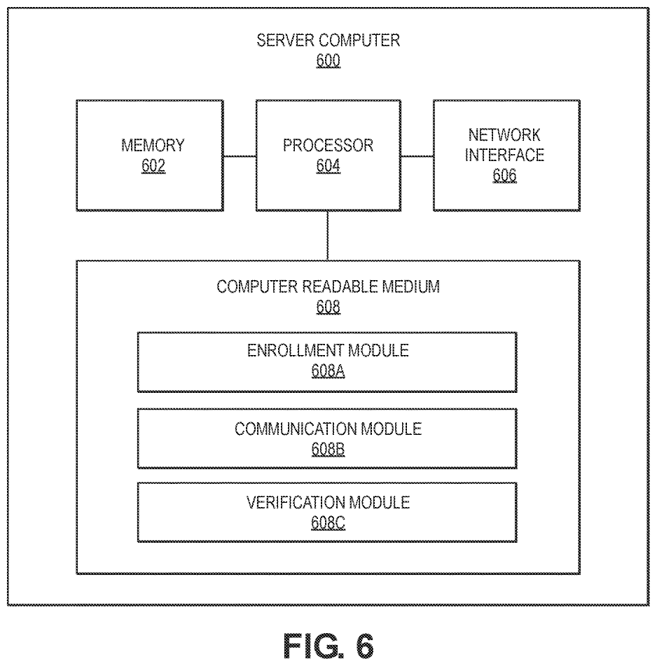

FIG. 6 illustrates a block diagram of a server computer according to embodiments. The server computer 600 can include a computer that can perform FIDO (fast identity online) authentication. The server computer 600 can maintain an association between primary account numbers (PANs) and devices, and manage account information. The server computer 600 can enroll and verify users using public-private key pair cryptography.

The server computer 600 may comprise a processor 604 coupled to a memory 602, a network interface 606 and a computer readable medium 608. The computer readable medium 608 can comprise an enrollment module 608A, a communication module 608B, and a verification module 608C.

The memory 602 can be used to store data and code. The memory 602 may be coupled to the processor 604 internally or externally (e.g., cloud-based data storage), and may comprise any combination of volatile and/or non-volatile memory, such as RAM, DRAM, ROM, flash, or any other suitable memory device. For example, the memory 602 can store credentials, tokens, resource provider identifiers, account information, etc.

The computer readable medium 608 may comprise code, executable by the processor 604, for performing a method comprising: receiving, from a user device storing a private key of a public-private key pair, a first attestation message comprising a first attestation data packet, the public key, a user device identifier for the user device, and a credential; binding the credential to the user device identifier; transmitting, to a token service computer, the first attestation data packet, wherein the token service computer previously bound a first token from a first token requestor interacting with the user device to the user device identifier; receiving, from a second token requestor interacting with the user device, a second attestation message comprising a second attestation data packet; verifying, the second attestation data packet using the public key; and transmitting, verification data to the second token requestor, which transmits the verification data to the token service computer, wherein the token service computer binds a second token associated with the second token requestor to the user device identifier.

The enrollment module 608A may comprise code or software, executable by the processor 604, for enrolling users with the server computer 600. For example, a user may provide the enrollment module 608A enrollment data including a user device identifier, a credential, and a public key. The enrollment module 608A, in conjunction with the processor 604, may store the enrollment data in a profile database.

The communication module 608B may comprise code that causes the processor 204 to generate messages, forward messages, reformat messages, and/or otherwise communicate with other entities. When an electronic message is received by the server computer 600 via the network interface 206, it may be passed to the communication module 608B. The communication module 608B, in conjunction with the processor 604, may identify and parse the relevant data based on a particular messaging protocol used in the system. The communication module 608B, in conjunction with the processor 604, may then transmit any received information to an appropriate module within the server computer 600 (e.g., via a data bus line, etc.). The communication module 608B may also receive information from one or more of the modules in the server computer 600 and generate an electronic message in an appropriate data format in conformance with a transmission protocol, such that the message may be sent to one or more entities. The electronic message may then be passed to the network interface 606 for transmission.

The verification module 608C may comprise code that causes the processor 604 to execute a verification process to authenticate a user. For example, the verification module 608C may, in conjunction with the processor 604, compare received data with stored data to verify the received data is authentic. The verification module 608C may, in conjunction with the processor 604, verify data using a public key.

The network interface 606 may include an interface that can allow the server computer 600 to communicate with external computers. The network interface 606 may enable the server computer 600 to communicate data to and from another device. Some examples of the network interface 606 may include a modem, a physical network interface (such as an Ethernet card or other Network Interface Card (NIC)), a virtual network interface, a communications port, a Personal Computer Memory Card International Association (PCMCIA) slot and card, or the like. The wireless protocols enabled by the network interface 606 may include WI-FITM Data transferred via the network interface 606 may be in the form of signals which may be electrical, electromagnetic, optical, or any other signal capable of being received by the external communications interface (collectively referred to as “electronic signals” or “electronic messages”). These electronic messages that may comprise data or instructions may be provided between the network interface 606 and other devices via a communications path or channel. As noted above, any suitable communication path or channel may be used such as, for instance, a wire or cable, fiber optics, a telephone line, a cellular link, a radio frequency (RF) link, a WAN or LAN network, the Internet, or any other suitable medium.

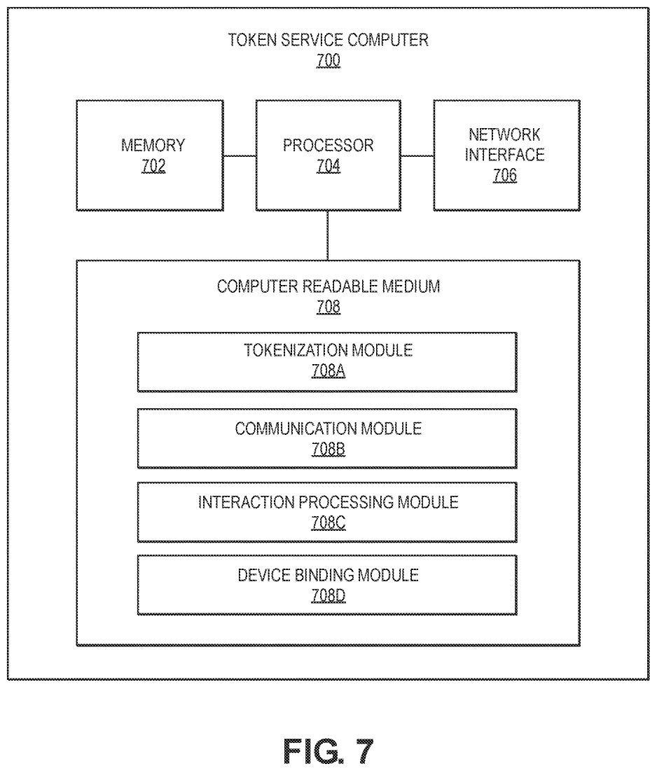

FIG. 7 shows a block diagram of a token service computer 700 according to embodiments. The exemplary token service computer 700 may comprise a processor 704. The processor 704 may be coupled to a memory 702, a network interface 706, and a computer readable medium 708. The computer readable medium 708 can comprise a tokenization module 708A, a communication module 708B, an interaction processing module 708C, and a device binding module 708D.

The memory 702 can be used to store data and code. For example, the memory 702 can store tokens, passkeys, token maps, etc. The memory 702 may be coupled to the processor 704 internally or externally (e.g., cloud-based data storage), and may comprise any combination of volatile and/or non-volatile memory, such as RAM, DRAM, ROM, flash, or any other suitable memory device.

The computer readable medium 708 may comprise code, executable by the processor 704, for performing a method comprising: receiving from a first token requestor computer, a first device binding request message comprising a user device identifier for a user device and a first token, wherein the first token is associated with a credential; initiating, a step-up authentication of the user via an authorizing entity computer associated with the credential; receiving an authentication response message; storing, the user device identifier with the token; receiving, from a server computer, an enrollment message comprising an enrollment data packet, a user device identifier for the user device, and the credential; receiving, from a second token requestor, a second device binding request message comprising verification data, the user device identifier, and a second token; determining, that the second token is associated with the credential; determining, that the credential is associated with the user device identifier; and without initiating a subsequent step-up authentication of the user via the authorizing entity computer, storing, the second token with the user device identifier.

The tokenization module 708A may comprise executable code for generating or determining tokens for credentials. The communication module 708B may be similar to the communication module 608B. The interaction processing module 708C may be programmed to process interactions. The device binding module 708D may comprise executable code for binding a token to a user device.

The network interface 706 may include an interface that can allow token service computer 700 to communicate with external computers. The network interface 706 may enable the token service computer 700 to communicate data to and from another device. Some examples of the network interface 706 may include a modem, a physical network interface (such as an Ethernet card or other Network Interface Card (NIC)), a virtual network interface, a communications port, a Personal Computer Memory Card International Association (PCMCIA) slot and card, or the like. The wireless protocols enabled by the network interface 706 may include Wi-FI™. Data transferred via the network interface 706 may be in the form of signals which may be electrical, electromagnetic, optical, or any other signal capable of being received by the external communications interface (collectively referred to as “electronic signals” or “electronic messages”). These electronic messages that may comprise data or instructions may be provided between the network interface 706 and other devices via a communications path or channel. As noted above, any suitable communication path or channel may be used such as, for instance, a wire or cable, fiber optics, a telephone line, a cellular link, a radio frequency (RF) link, a WAN or LAN network, the Internet, or any other suitable medium.

Embodiments of the disclosure have a number of technical advantages. Embodiments can identify and recognize a device across a plurality of interactions with different tokens associated with different token requestors. Embodiments provide secure methods for interaction processing using tokenization and passkeys without sacrificing user convenience. A user can complete a device binding enrollment process and an enrollment process to reduce the need for subsequent step-up authentications with an authorizing entity. As compared to traditional protocol, embodiments can reduce the number of excessive authentications, thereby saving on time and computer resources.

Other technical advantages relate to the use of tokens instead of credentials in embodiments of the invention. Tokens protect sensitive credentials such as account numbers from hacking and man-in-the-middle attacks, since the sensitive credentials are not exposed during transaction. Thus, tokens provide data security for sensitive credentials.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g., a hard drive, a CD, or an entire computer system), and may be present on or within different computer products within a system or network. A computer system may include a monitor, printer, or other suitable display for providing any of the results mentioned herein to a user.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

As used herein, the use of “a,” “an,” or “the” is intended to mean “at least one,” unless specifically indicated to the contrary.

What is claimed is:

1. A method comprising:
receiving, by a server computer from a user device storing a private key of a public-private key pair, a first attestation message comprising a first attestation data packet, a public key of the public-private key pair, a user device identifier for the user device, and a credential;
binding, by the server computer, the credential to the user device identifier;
transmitting, by the server computer to a token service computer, the first attestation data packet, wherein the token service computer previously bound a first token from a first token requestor interacting with the user device to the user device identifier;
receiving, by the server computer from a second token requestor interacting with the user device, a second attestation message comprising a second attestation data packet;
verifying, by the server computer, the second attestation data packet using the public key; and
transmitting, by the server computer, verification data to the second token requestor, which transmits the verification data to the token service computer, wherein the token service computer binds a second token associated with the second token requestor to the user device identifier.

2. The method of claim 1, wherein the first token and the second token are associated with the credential.

3. The method of claim 1, wherein the second attestation data packet comprises data signed by the private key, wherein verifying the second attestation data packet comprises verifying the data signed by the private key using the public key.

4. The method of claim 3, wherein the data signed by the private key is signed upon the user device receiving a user biometric.

5. The method of claim 3, further comprising, prior to binding the credential to the user device identifier, verifying, by the server computer, the first attestation data packet.

6. The method of claim 1, wherein the token service computer binds the second token, the user device identifier, and the credential.

7. The method of claim 1, wherein the token service computer binds the second token to the user device identifier after determining that the second token is associated with the credential and the credential is associated with the first token bound to the user device identifier.

8. The method of claim 1, wherein the token service computer previously bound the first token to the user device identifier after completion of a step-up authentication of a user of the user device via an authorizing entity computer, and wherein the token service computer binds the second token to the user device identifier without the authorizing entity computer performing a subsequent step-up authentication of the user.

9. The method of claim 1, wherein the second token requestor obtains the second attestation message from the user device after the user device receives a user biometric and signs data in the second attestation data packet using the private key.

10. The method of claim 1, wherein the user device is a mobile phone.

11. A method comprising:
receiving, by a token service computer from a first token requestor computer, a first device binding request message comprising a user device identifier for a user device and a first token, wherein the first token is associated with a credential;
initiating, by the token service computer, a step-up authentication of a user of the user device via an authorizing entity computer associated with the credential;
receiving, by the token service computer, an authentication response message;
storing, by the token service computer, the user device identifier with the first token;
receiving, by the token service computer from a server computer, an enrollment message comprising an enrollment data packet, the user device identifier for the user device, and the credential;
receiving, by the token service computer from a second token requestor, a second device binding request message comprising verification data, the user device identifier, and a second token;
determining, by the token service computer, that the second token is associated with the credential;
determining, by the token service computer, that the credential is associated with the user device identifier; and
without initiating a subsequent step-up authentication of the user via the authorizing entity computer, storing, by the token service computer, the second token with the user device identifier.

12. The method of claim 11, wherein initiating the step-up authentication of the user comprises:
providing, by the token service computer, a token provisioning request message to the authorizing entity computer;
receiving, by the token service computer, a token provisioning response message from the authorizing entity computer in response to the token provisioning request message, wherein the token provisioning response message indicates initiation of the step-up authentication;
generating, by the token service computer, a get verification methods message;
providing, by the token service computer, the get verification methods message to the authorizing entity computer;
receiving, by the token service computer, one or more verification methods; and
providing, by the token service computer, the one or more verification methods to the first token requestor computer; wherein the first token requestor computer provides the one or more verification methods to the user device.

13. The method of claim 12, wherein the user of the user device selects a selected verification method of the one or more verification methods and the user and/or the user device is verified using the selected verification method.

14. The method of claim 11, wherein the token service computer stores the second token, the user device identifier, and a credential identifier in association with each other.

15. The method of claim 11, wherein the verification data indicates the user device was authenticated by the server computer.

16. A server computer comprising:
a processor; and
a non-transitory computer-readable medium comprising code that, when executed by the processor, causes the processor to perform a method including:
receiving, from a user device storing a private key of a public-private key pair, a first attestation message comprising a first attestation data packet, a public key of the public-private key pair, a user device identifier for the user device, and a credential;
binding the credential to the user device identifier;
transmitting, to a token service computer, the first attestation data packet, wherein the token service computer previously bound a first token from a first token requestor interacting with the user device to the user device identifier;
receiving, from a second token requestor interacting with the user device, a second attestation message comprising a second attestation data packet;
verifying, the second attestation data packet using the public key; and
transmitting verification data to the second token requestor, which transmits the verification data to the token service computer, wherein the token service computer binds a second token associated with the second token requestor to the user device identifier.

17. The server computer of claim 16, wherein the first token and the second token are associated with the credential.

18. The server computer of claim 16, wherein the second attestation data packet comprises data signed by the private key, wherein verifying the second attestation data packet comprises verifying the data signed by the private key using the public key.

19. The server computer of claim 16, wherein the first token has a same format as the credential.

20. The server computer of claim 16, wherein binding the credential to the user device identifier comprises storing the credential in association with the user device identifier.
